(19) United States
(12) Patent Application Publication
(10) Pub. No.: US 2025/0342038 A1
(43) Pub. Date: Nov. 6, 2025

(54) BRANCH PREDICTION WITH NEXT PROGRAM COUNTER CACHES

(71) Applicant: Akeana, Inc., Santa Clara, CA (US)

(72) Inventors: Edwin R Sutanto, Freemont, CA (US); Rabin Sugumar, Sunnyvale, CA (US)

(73) Assignee: Akeana, Inc., Santa Clara, CA (US)

(21) Appl. No.: 19/268,170

(22) Filed: Jul. 14, 2025

Related U.S. Application Data
(63) Continuation-in-part of application No. 18/534,786, filed on Dec. 11, 2023, now Pat. No. 12,360,769.
(60) Provisional application No. 63/431,756, filed on Dec. 12, 2022.
(60) Provisional application No. 63/434,104, filed on Dec. 21, 2022.
(60) Provisional application No. 63/435,343, filed on Dec. 27, 2022.
(60) Provisional application No. 63/435,831, filed on Dec. 29, 2022.
(60) Provisional application No. 63/436,133, filed on Dec. 30, 2022.
(60) Provisional application No. 63/436,144, filed on Dec. 30, 2022.
(60) Provisional application No. 63/439,761, filed on Jan. 18, 2023.
(60) Provisional application No. 63/444,619, filed on Feb. 10, 2023.
(60) Provisional application No. 63/462,542, filed on Apr. 28, 2023.
(60) Provisional application No. 63/463,371, filed on May 2, 2023.
(60) Provisional application No. 63/467,335, filed on May 18, 2023.
(60) Provisional application No. 63/471,283, filed on Jun. 6, 2023.
(60) Provisional application No. 63/521,365, filed on Jun. 16, 2023.
(60) Provisional application No. 63/526,009, filed on Jul. 11, 2023.
(60) Provisional application No. 63/542,797, filed on Oct. 6, 2023.
(60) Provisional application No. 63/545,961, filed on Oct. 27, 2023.
(60) Provisional application No. 63/546,769, filed on Nov. 1, 2023.
(60) Provisional application No. 63/547,404, filed on Nov. 6, 2023.
(60) Provisional application No. 63/547,574, filed on Nov. 7, 2023.
(60) Provisional application No. 63/602,514, filed on Nov. 24, 2023.
(60) Provisional application No. 63/605,620, filed on Dec. 4, 2023.
(60) Provisional application No. 63/679,192, filed on Aug. 5, 2024.
(60) Provisional application No. 63/679,685, filed on Aug. 6, 2024.
(60) Provisional application No. 63/687,795, filed on Aug. 28, 2024.
(60) Provisional application No. 63/690,822, filed on Sep. 5, 2024.
(60) Provisional application No. 63/691,351, filed on Sep. 6, 2024.
(60) Provisional application No. 63/699,245, filed on Sep. 26, 2024.
(60) Provisional application No. 63/702,192, filed on Oct. 2, 2024.
(60) Provisional application No. 63/714,529, filed on Oct. 31, 2024.
(60) Provisional application No. 63/719,841, filed on Nov. 13, 2024.
(60) Provisional application No. 63/730,997, filed on Dec. 12, 2024.
(60) Provisional application No. 63/735,937, filed on Dec. 19, 2024.
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.
(60) Provisional application No. 63/777,814, filed on Mar. 26, 2025.
(60) Provisional application No. 63/795,829, filed on Apr. 28, 2025.
(60) Provisional application No. 63/797,195, filed on Apr. 30, 2025.
(60) Provisional application No. 63/803,977, filed on May 12, 2025.

(51) Int. Cl. G06F 9/38; G06F 9/30

(52) U.S. Cl. CPC G06F 9/3806; G06F 9/3005; G06F 9/30101

(57) ABSTRACT

A processor core is accessed. The processor core includes a direct next program counter cache (DNPC) that includes multiple entries. The processor core executes a branch instruction associated with a program counter (PC) address. An entry within the DNPC that matches a tag associated with the PC address is found. An indirect bit within the matching entry is read. In cases where the indirect bit is not set, a branch target address for the branch instruction is produced by the DNPC. The DNPC generates a prediction for the branch instruction. The prediction is based on a local history register within the entry of the DNPC that matched the tag. A next PC address is determined, based on the branch target address that was produced and the prediction that was generated. The DNPC includes a plurality of prediction tables. Each prediction table is associated with each entry within the DNPC.

### RELATED APPLICATIONS

This application claims the benefit of U.S. provisional patent applications “Weight-Stationary Matrix Multiply Accelerator With Tightly Coupled L2 Cache” Ser. No. 63/679,192, filed Aug. 5, 2024, “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702, 192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764, 198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, and “Single Cycle Move Instruction Elimination With Multiple Dependencies In A Dispatch Bundle” Ser. No. 63/831,282, filed Jun. 27, 2025.

This application is also a continuation-in-part of U.S. patent application “Branch Target Buffer Operation With Auxiliary Indirect Cache” Ser. No. 18/534,786, filed Dec. 11, 2023, which claims the benefit of U.S. provisional patent applications “Branch Target Buffer Operation With Auxiliary Indirect Cache” Ser. No. 63/431,756 filed Dec. 12, 2022, “Processor Performance Profiling Using Agents” Ser. No. 63/434,104, filed Dec. 21, 2022, “Prefetching With Saturation Control” Ser. No. 63/435,343, filed Dec. 27, 2022, “Prioritized Unified TLB Lookup With Variable Page Sizes” Ser. No. 63/435,831, filed Dec. 29, 2022, “Return Address Stack With Branch Mispredict Recovery” Ser. No. 63/436,133, filed Dec. 30, 2022, “Coherency Management Using Distributed Snoop” Ser. No. 63/436,144, filed Dec. 30, 2022, “Cache Management Using Shared Cache Line Storage” Ser. No. 63/439,761, filed Jan. 18, 2023, “Access Request Dynamic Multilevel Arbitration” Ser. No. 63/444,619, filed Feb. 10, 2023, “Processor Pipeline For Data Transfer Operations” Ser. No. 63/462,542, filed Apr. 28, 2023, “Out-Of-Order Unit Stride Data Prefetcher With Scoreboarding” Ser. No. 63/463,371, filed May 2, 2023, “Architectural Reduction Of Voltage And Clock Attach Windows” Ser. No. 63/467,335, filed May 18, 2023, “Coherent Hierarchical Cache Line Tracking” Ser. No. 63/471,283, filed Jun. 6, 2023, “Direct Cache Transfer With Shared Cache Lines” Ser. No. 63/521,365, filed Jun. 16, 2023, “Polarity-Based Data Prefetcher With Underlying Stride Detection” Ser. No. 63/526,009, filed Jul. 11, 2023, “Mixed-Source Dependency Control” Ser. No. 63/542,797, filed Oct. 6, 2023, “Vector Scatter And Gather With Single Memory Access” Ser. No. 63/545,961, filed Oct. 27, 2023, “Pipeline Optimization With Variable Latency Execution” Ser. No. 63/546,769, filed Nov. 1, 2023, “Cache Evict Duplication Management” Ser. No. 63/547,404, filed Nov. 6, 2023, “Multi-Cast Snoop Vectors Within A Mesh Topology” Ser. No. 63/547,574, filed Nov. 7, 2023, “Optimized Snoop Multi-Cast With Mesh Regions” Ser. No. 63/602,514, filed Nov. 24, 2023, and “Cache Snoop Replay Management” Ser. No. 63/605,620, filed Dec. 4, 2023.

Each of the foregoing applications is hereby incorporated by reference in its entirety.

### FIELD OF ART

This application relates generally to instruction execution and more particularly to branch prediction with next program counter caches.

### BACKGROUND

High-performance processors play a pivotal role in modern computing equipment, serving as the backbone for a wide range of applications that demand speed, efficiency, and responsiveness. In the realm of communications, fast processors are essential for real-time data handling, enabling high-speed internet, seamless video conferencing, and rapid data encryption and decryption. These capabilities are especially critical in modern 5G infrastructure and cloud-based networking environments, where latency and reliability are paramount.

In the world of gaming, high-performance processors enhance gameplay experiences by supporting complex physics simulations, AI-driven behaviors, and high frame rates. These processors allow games to render immersive 3D environments and deliver smooth, low-lag interactions that meet the expectations of both casual players and professional e-sports athletes. Similarly, ecommerce platforms benefit from rapid transaction processing, fraud detection algorithms, and personalized recommendation engines that are powered by robust processor capabilities. This ensures that users experience fast load times, secure checkouts, and dynamic content delivery.

Similarly, high-performance processors are particularly useful for handling cryptocurrency and blockchain operations, where computational intensity and efficiency are crucial. In blockchain networks, especially those using proof-of-work consensus algorithms like Bitcoin, mining involves solving complex cryptographic puzzles, which is a task that demands significant processing power. Even in newer models like proof-of-stake or delegated proof-of-stake, high-performance processors facilitate rapid transaction verification, smart contract execution, and node synchronization, helping maintain the integrity and speed of the decentralized ledger. Additionally, as blockchain applications expand into areas such as decentralized finance (DeFi), Non-Fungible Token (NFT) platforms, and secure digital identity management, fast processors ensure that these services can scale effectively while delivering low latency and high throughput. This makes them indispensable for both individual miners and enterprise-grade blockchain infrastructure.

High-performance processors also play a critical role in the efficiency and scalability of machine learning systems, especially as models grow in complexity and datasets expand in size. These processors can enable faster training times for deep learning models, support real-time inference tasks, and handle the parallel computation demands of neural networks. In applications ranging from autonomous vehicles to natural language processing and medical diagnostics, high-performance processors can accelerate data processing, reduce latency, and enable more sophisticated models to run efficiently. Their ability to handle large volumes of data and perform billions of operations per second is essential for pushing the boundaries of what machine learning can achieve in both research and real-world deployments.

Advancements in processor technology frequently serve as a catalyst for system-wide efficiency improvements. High-performance processors can significantly reduce overall energy consumption by completing complex tasks more rapidly and transitioning into low-power states sooner, thereby extending battery life in portable devices and reducing operational costs in data centers. Moreover, they enhance multitasking capabilities, enabling users to seamlessly run multiple demanding applications in parallel without sacrificing responsiveness or performance. As modern computing ecosystems become increasingly interconnected, spanning edge devices, IoT networks, and cloud infrastructure, high-speed processors play a pivotal role in maintaining consistent, low-latency performance, ensuring reliable computation regardless of the physical location where processing occurs.

Beyond these areas, high-performance processors are beneficial for sectors such as finance, healthcare, entertainment, and more. In each case, the processor acts as a key enabler, reducing computation times and allowing for real-time or near-real-time decision making. As digital infrastructure continues to expand, and the demand for instantaneous computing grows, high-performance processors will remain essential for driving innovation and sustaining the performance needs of a connected world.

### SUMMARY

Effective branch prediction plays an important role in optimizing processor performance by minimizing the penalties associated with branch mispredictions. In modern processors, instructions are executed in deeply pipelined architectures, where control flow decisions, such as conditional branches, can disrupt the flow of instruction execution. Without accurate branch prediction, the processor may waste cycles waiting for the correct path to be determined, leading to pipeline stalls and reduced efficiency. By leveraging advanced branch prediction techniques, such as dynamic predictors that adapt based on execution history, two-level branch predictors, and hybrid prediction models, the processor can speculatively execute instructions along the most likely path, thereby maximizing instruction throughput and minimizing wasted computation cycles.

Disclosed techniques enable improved branch prediction. A processor core is accessed, where the processor core includes a direct next program counter cache (DNPC) that includes multiple entries. The processor core executes a branch instruction associated with a program counter (PC) address. An entry within the DNPC that matches a tag associated with the PC address is found. An indirect bit within the matching entry is read. In cases where the indirect bit is not set, a branch target address for the branch instruction is produced by the DNPC. The DNPC generates a prediction for the branch instruction, where the prediction is based on a local history register (LHR) within the entry of the DNPC that matched the tag. A next PC address is determined, based on the branch target address that was produced and the prediction that was generated.

A processor-implemented method for instruction execution is disclosed comprising: accessing a processor core, wherein the processor core is configured to predict branch instructions, wherein the processor core includes a direct next program counter cache (DNPC), wherein the DNPC comprises a plurality of entries, and wherein the processor core fetches a branch instruction, wherein the branch instruction is associated with a program counter (PC) address; finding, within the DNPC, an entry, within the plurality of entries, that matches a tag, wherein the tag is associated with the PC address, and wherein the finding includes reading an indirect bit within the entry of the DNPC that matches the tag; producing, by the DNPC, a branch target address for the branch instruction, wherein the indirect bit is not set within the entry of the DNPC that matches the tag; generating, by the DNPC, a prediction for the branch instruction, wherein the prediction is based on a local history register (LHR) within the entry of the DNPC that matched the tag; and determining a next PC address, wherein the determining is based on the producing and the generating. In embodiments, the DNPC includes a plurality of prediction tables, wherein each prediction table within the plurality of prediction tables is associated with each entry within the plurality of entries within the DNPC. In embodiments, the generating includes indexing, by the LHR, into a prediction table within the entry of the DNPC that matched the tag. Some embodiments comprise updating the LHR. In embodiments, the updating is based on a prediction from an additional branch predictor.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for branch prediction with next program counter caches.

FIG. 2 is a flow diagram for predicting branches with an indirect next program counter cache.

FIG. 3 is a block diagram for fetching instructions with next program counter caches.

FIG. 4 is a diagram of a 3-bit local history register.

FIG. 5 is a diagram of a DNPC.

FIG. 6 is a block diagram of a multicore processor.

FIG. 7 is a block diagram of a pipeline.

FIG. 8 is a system diagram for branch prediction with next program counter caches.

### DETAILED DESCRIPTION

Branch prediction can enhance the effectiveness of speculative execution and out-of-order processing, allowing processors to achieve higher instruction-level parallelism. When combined with branch target buffers and sophisticated misprediction recovery mechanisms, such as selective rollback techniques, branch prediction can ensure minimal disruption to the pipeline. This is particularly vital for high-performance computing applications, where even minor inefficiencies can significantly impact overall execution speed. Early, accurate branch prediction is particularly beneficial in pipelined architectures, as early branch prediction allows instruction fetch units to maintain a steady flow of useful instructions without unnecessary stalls. The sooner a processor correctly predicts a branch, the earlier the processor can speculatively execute subsequent instructions, avoiding costly misprediction penalties. Early branch prediction is especially important in RISC processors which rely on high instruction throughput and streamlined execution pipelines to achieve performance gains. Since RISC architectures emphasize simple instructions executed in a uniform cycle pattern, any delay in determining the correct branch path disrupts the efficiency of the pipeline. By implementing early and accurate branch prediction, the processor can reduce bubbles in the instruction stream, can improve instruction-level parallelism, and can keep functional units busy, maximizing processing efficiency in workloads that involve frequent branching.

Techniques for branch prediction are disclosed. A processor core which is configured to predict branch instructions is accessed. The processor core includes a direct next program counter cache (DNPC) which comprises a plurality of entries. In embodiments, the DNPC includes a plurality of prediction tables. In embodiments, each prediction table is associated with each entry within the plurality of entries within the DNPC. The processor core fetches a branch instruction which is associated with a program counter (PC) address. An entry within the DNPC that matches a tag is found. The tag is associated with the PC address. An indirect bit within the entry of the DNPC that matches the tag is read. The DNPC produces a branch target address for the branch instruction when the indirect bit is not set within the entry of the DNPC that matched the tag. The DNPC generates a prediction for the branch instruction. The prediction is based on a local history register (LHR) within the entry of the DNPC that matched the tag. In embodiments, the generating includes indexing, by the LHR, into a prediction table within the entry of the DNPC that matches the tag. A next PC address is determined based on the producing and the generating. In embodiments, the processor core includes an indirect next program counter cache (INPC). The INPC can locate an entry that matches the tag and generated a second branch target address. When the indirect bit is set within the entry of the DNPC that matched the entry, the second branch target address can be selected. In this case, the branch instruction can be predicted as taken.

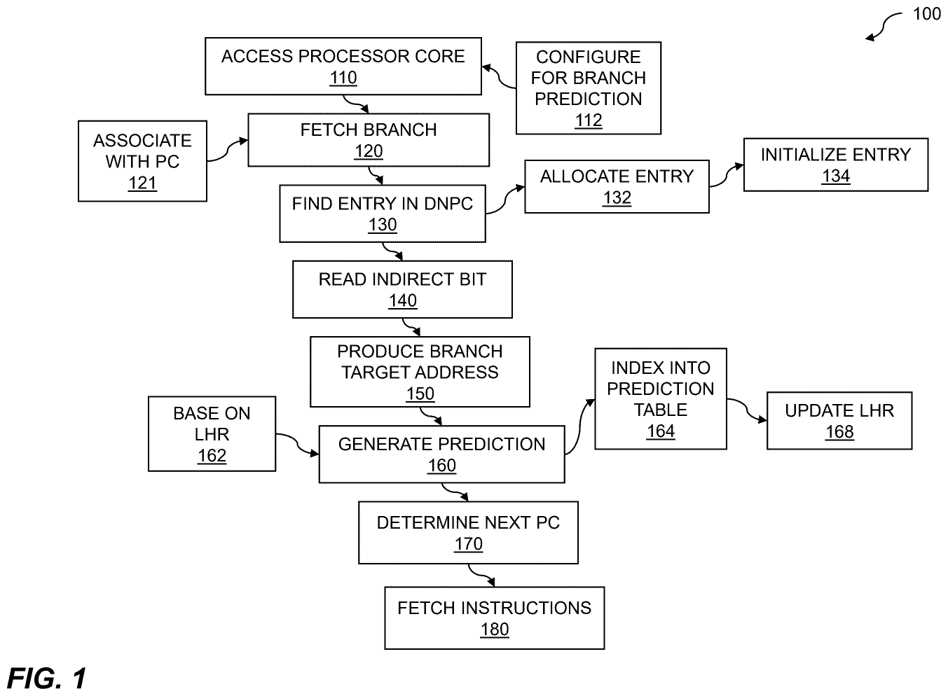

FIG. 1 is a flow diagram for branch prediction with next program counter caches. The flow 100 includes accessing a processor core 110. Embodiments include accessing a processor core, wherein the processor core is configured to predict branch instructions 112, wherein the processor core includes a direct next program counter cache (DNPC), wherein the DNPC comprises a plurality of entries, and wherein the processor core fetches a branch instruction 120, wherein the branch instruction is associated with a program counter (PC) address 121. The processor core can be included on a multi-processor chip, an application specific integrated circuit (ASIC), a system-on-a-chip (SOC), and so on. The processor core can include a RISC-V core, MIPS core, ARM core, and so on. The processor core can execute instructions that are part of an instruction set architecture (ISA) such as X86, ARM, and so on. The processor core can be coupled to a memory hierarchy. The memory hierarchy can include L1, L2, L3, etc. caches. The memory hierarchy can include memory such as DRAM, SRAM, and so on. The memory hierarchy can be coherent or non-coherent.

The flow 100 includes configuring the processor core to predict branch instructions 112. Branch prediction is an important feature in modern processors that helps maintain smooth instruction flow by guessing the outcome of conditional branch instructions before they are fully resolved during the execution of the branch instruction. The processor core includes a direct next program counter cache (DNPC). The DNPC can include any number of entries. In embodiments, the DNPC comprises a two-way set associative cache. The DNPC can comprise a direct mapped cache or any other associativity. The branch prediction can utilize a DNPC and an indirect next program counter cache (INPC) in tandem to predict direct and indirect branches. This approach can enable the processor to speculatively fetch and execute instructions without waiting for the branch condition to be fully evaluated, thereby minimizing pipeline stalls.

The flow 100 includes fetching a branch instruction 120. The fetching can be controlled by a fetch unit which can retrieve one or more instructions, cache lines, blocks, etc. from the memory hierarchy. Subsequent states can include decode (where the processor core identifies a branch instruction) and execute (where the branch instruction is evaluated to determine whether it should be taken or not taken). The fetching can be based on a program counter (PC) address, which can be a next PC address. The flow 100 can include associating the branch instruction with a program counter (PC) address 121. The branch condition can include a comparison, such as a comparison between registers. If the branch instruction is conditional, the result of the condition determines whether the branch is taken. If the branch instruction is predicted as taken, the PC is updated to a target address, otherwise, the processor execution continues to the next instruction address, for example PC+4.

The flow 100 includes finding an entry in the DNPC. Embodiments include finding, within the DNPC, an entry 130, within the plurality of entries, that matches a tag, wherein the tag is associated with the PC address, and wherein the finding includes reading an indirect bit 140 within the entry of the DNPC that matches the tag. The DNPC can be indexed by the tag. The tag can comprise the PC, a subset of the bits of the PC, hashes of some or all of the bits of the PC, and so on. Disclosed implementations may use the entire program counter (PC) for the tag, to ensure that each branch instruction has a unique mapping (e.g., to avoid aliasing within the DNPC). However, this approach can increase complexity. Other implementations may utilize a subset of the PC, such as the lower 10 to 16 bits, leveraging the fact that nearby instructions often have different least significant bits while still keeping the table size manageable. Some implementations may utilize hashing techniques to improve distribution and reduce aliasing. Some implementations may combine parts of the PC (such as by XORing the upper and lower bits) and/or mix the PC with the branch history register to form a richer, more unique index.

When an instruction is fetched, the PC of the fetched instruction can be used as a base for the tag, as described above. The tag can be presented to the DNPC to determine if a valid entry exists for the instruction. If so, the lookup of the DNPC results in a hit, and branch information can be read/updated (described below). If the tag does not match any elements in the DNPC, a miss can result. In this case, a new entry within the DNPC can be created to store the branch instruction that was fetched. In embodiments, the finding includes allocating a new entry 132 within the DNPC. A valid bit can indicate whether an entry of the DNPC is empty or full. If no unallocated rows are available (e.g., the DNPC is full), a replacement policy may be used to enable the new row to be allocated by evicting a previously entered row. The replacement policy can include evicting existing entries from the DNPC. Evicting old entries from a branch prediction cache can be performed to maintain prediction accuracy and performance as program behavior evolves. Disclosed implementations may utilize the Least Recently Used (LRU) approach, which removes the cache entry that has gone the longest without being accessed, favoring entries that reflect current branching patterns. Other implementations may utilize a Least Frequently Used (LFU) approach, which evicts entries that have been used the least over time, assuming they are less critical to ongoing prediction accuracy.

Each entry within the DNPC can include a local history register (LHR). The LHR can record a sequential history of predictions of the specific branch instruction that is stored within the entry within the DNPC. In disclosed implementations, the LHR can have fewer bits than a global history register (GHR), which can track the taken/not taken history of all branches, allowing for faster access times and reduced hardware complexity. Using a local history register also allows disclosed methods to take advantage of local branch locality. The LHR can be updated based on a prediction from an additional branch predictor, such as a TAGE predictor, TAGE cache, and so on. In embodiments, the LHR is updated based on execution of the branch instruction. When updated, the LHR can be shifted left with the actual direction of the branch. In the LHR, a “1” can indicate taken and a “0” can indicate not taken. Thus, an N-bit LHR can represent the last N directions of branch instructions. The LHR can include any number of bits, such as two bits, three bits, twelve bits, and so on. Each entry within the DNPC can also include a prediction table. The LHR can index into the prediction table (described later). Thus, if two bits are used for the LHR, each prediction table can be four entries; if three bits are used for the LHR, each prediction table can comprise eight entries; and so on. The prediction table can be used to predict the direction of the branch by the DNPC, when indexed by the LHR. The prediction table can also be updated by the outcome of the branch instruction when executed or predicted by another branch predictor, such as a TAGE branch predictor, a TAGE cache, and so on.

The flow 100 includes initializing an entry 134. Embodiments include initializing the LHR and a prediction table within the new entry, wherein the initializing is based on a prediction from an additional branch predictor. Once an empty entry is located within the DNPC, or room is made for a new entry within the DNPC, the entry can be initialized. The initialization can include one or more fields within the DNPC and can include other branch prediction schemes. As described above, each entry can include a local history register (LHR) associated with the entry, a prediction table associated with the entry, a valid bit, and so on. Since the prediction of the branch instruction is not known by the DNPC when the entry is initiated, the initialization can include a prediction from an additional branch predictor, such as a TAGE branch predictor or a TAGE cache, which can store previous predictions from the TAGE branch predictor. The initialization can include setting the LHR to “000,” updating an entry within the prediction table pointed to by the LHR of “000” to the prediction of the additional branch predictor, setting the valid bit, and so on.

The flow 100 includes reading an indirect bit 140. The indirect bit 140 can include a bit within a row, entry, etc. of the DNPC that indicates if the branch instruction that was fetched is known as a direct branch instruction or an indirect branch instruction. A direct branch instruction and an indirect branch instruction differ in how the target address is specified and resolved during execution. In a direct branch instruction, the target address is explicitly encoded as an immediate value within the instruction itself, which can be an offset added to the current program counter (PC). This makes the target of direct branches simple and fast to generate. In contrast, an indirect branch determines its target dynamically, using an operand that refers to a register or memory location holding the actual address to jump to. For example, a function return might branch to the address stored in a link register, or a virtual method call might branch to an address fetched from memory through a pointer. Indirect branches add flexibility, enabling dynamic control flow such as in function pointers, jump tables, and virtual dispatch. However, it can be more challenging to determine the target of an indirect branch since the target can vary widely at runtime and is not known until later in the pipeline. The indirect bit can be used to select between a result from the DNPC or an indirect next program counter cache (described below).

The flow 100 proceeds with producing a branch target address 150. Embodiments include producing, by the DNPC, a branch target address for the branch instruction, wherein the indirect bit is not set within the entry of the DNPC that matches the tag. When there is a hit in the DNPC and the corresponding indirect bit is not set, this indicates that the entry represents a direct branch instruction. The DNPC can generate a branch target address and a prediction for direct branches stored. The branch target address can be stored in the DNPC. The branch target address can be updated based on the opcode of the instruction, based on an additional branch predictor, based on execution, and so on. Another memory structure, an indirect next program counter cache (INPC) can generate a target address for indirect branches. In the case of indirect branches, disclosed embodiments include always predicting a taken path.

The flow 100 continues with generating a prediction 160. Embodiments include generating, by the DNPC, a prediction for the branch instruction, wherein the prediction is based on a local history register (LHR) 162 within the entry of the DNPC that matched the tag. As described above, each entry of the DNPC can include an LHR which can record the sequential taken/not taken history of the branch saved within each entry of the DNPC. In embodiments, the generating includes indexing, by the LHR, into a prediction table 164 within the entry of the DNPC that matched the tag. The DNPC includes a plurality of prediction tables, wherein each prediction table within the plurality of prediction tables is associated with each entry within the plurality of entries within the DNPC. The number of prediction table entries can be based on the number of bits used for the LHR. For example, when the LHR is two bits, the prediction table can comprise four entries. When the LHR is three bits, the prediction table can comprise eight entries. Any number of LHR bits and corresponding prediction table entries can be used. When a branch is encountered, the DNPC can be accessed to determine if there is a hit. If there is a hit, and if the indirect bit is not set, the current LHR value can be used to index into the prediction table. The resulting entry of the prediction table can determine a taken/not taken prediction for the branch instruction. The LHR and the prediction table entry can be updated by disclosed methods. Indexing into the prediction table can provide fast and accurate branch prediction based on local branch history.

Embodiments include updating the LHR 168. In embodiments, the updating is based on a prediction from an additional branch predictor. Recall that the LHR can be incremented or decremented based on the prediction from an additional branch predictor. In some embodiments, the additional branch predictor comprises a tagged geometric (TAGE) branch predictor. The TAGE predictor can combine multiple history lengths for better branch prediction accuracy. In other embodiments, the additional branch predictor comprises a tagged geometric (TAGE) cache. A TAGE cache can store recent prediction results from a TAGE branch predictor. The TAGE cache can generate faster results than the TAGE predictor, while the TAGE predictor can generate more accurate results. The updating can be based on a TAGE branch prediction method or another branch prediction method. In some implementations, the additional branch predictor can include a gshare predictor, in which the program counter can be combined with a global history register (GHR) using a logical operation (e.g., XOR) to generate an index into a prediction table. In some implementations, the additional branch predictor can include a perceptron predictor, in which a weighted sum of bits from the GHR can be used to predict the branch outcome. Other types of branch predictors may be used in some implementations. In embodiments, the updating is based on execution of the branch instruction. After execution, the direction of the branch is fully known and thus the updating can be based on the most accurate information. However, resolution of the branch can take many cycles causing a delay to the updating. In a usage example, the LHR comprises “010.” If the additional branch predictor indicates that this branch should be taken, then the prediction table entry indexed by the LHR of “010” can be updated to “predict taken” (which can be represented, for example, by a “1” in the “010” entry of the table). Recall that the LHR can be updated by shifting left. The new value of the LHR can be shifted left to include the result of the most recently taken condition of the branch. Thus, the LHR can be updated to a new value of “101.”

The flow 100 includes determining a next PC 170. Embodiments include determining a next PC address, wherein the determining is based on the producing and the generating. The target address associated with a branch instruction can depend on whether the branch is taken or not taken. If the branch instruction is predicted as taken, a target address is determined. In the case of direct branching, the determination of the target address can be based on an operand of the branch instruction, such as an immediate value. The value of the target address can be stored in a cache such as the DNPC. For an indirect branch instruction, the determination of the target address can include referencing a value stored in a register or at a memory location to obtain the target address. If the branch instruction is predicted as not taken, the target address corresponds to a next sequential instruction, such as the instruction located at the current PC value incremented by an instruction length, such as 4 bytes. To generate the target address, the DNPC can be accessed. If a hit results on the tag, and the indirect bit is not set, the DNPC can return a target address stored in the cache.

The flow 100 includes fetching instructions 180. Embodiments include fetching, by the processor core, one or more instructions, wherein the fetching is based on the determining. The fetching of instructions can be based on the branch prediction. The fetching can be part of a speculative execution strategy, where instructions are fetched and potentially executed before the actual outcome of a branch instruction is resolved. If the speculation turns out to be correct, one or more execution cycles can be saved, as the processor avoids idle cycles and maintains continuous instruction throughput. In cases where the speculation turns out to be incorrect, the pipeline may need to be flushed or partially flushed/restarted, and the speculatively executed instructions are discarded. Such flushing can introduce penalties in the form of lost cycles and increased latency, as the processor must re-fetch and re-execute instructions from the correct path. When the branch prediction success rate is sufficiently high, there is a net positive performance gain, with more cycles saved from correct speculative execution than cycles lost from discarding incorrect speculative instructions. Disclosed implementations can provide an improved branch prediction success rate that can enable improvements in branch prediction accuracy, significantly enhancing the overall efficiency and performance of the processor. Embodiments can include fetching, by the processor core, one or more instructions, wherein the fetching is based on the determining.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

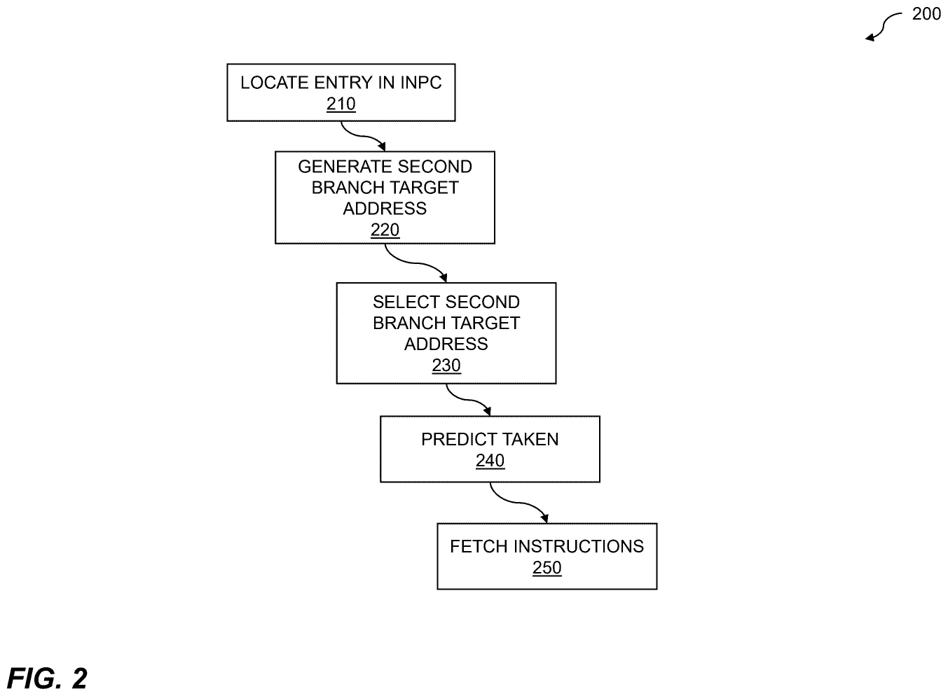

FIG. 2 is a flow diagram for predicting branches with an indirect next program counter cache. In embodiments, the processor core includes an indirect next program counter cache (INPC). The INPC can complement the DNPC in performing branch prediction. While the DNPC can be used for predicting direct branches and providing a target address, the INPC can be used to generate target addresses of indirect branches. In embodiments, the INPC comprises a content addressable memory (CAM). The CAM can be of any size. The INPC can comprise any memory storage structure.

The flow 200 includes locating an entry in the INPC 210. Embodiments include locating, in the INPC, an entry that matches the tag. Recall that a tag can comprise the PC, a subset of the bits of the PC, hashes of some or all of the bits of the PC, and so on. Disclosed implementations may use the entire program counter (PC) for the tag, to ensure that each branch instruction has a unique mapping (e.g., to avoid aliasing). The same tag used for the DNPC can be used for the INPC. In embodiments, the finding and the locating occur on a same cycle. The DNPC and the INPC can be accessed on the same cycle. The locating can be performed in conjunction with checking an indirect bit within the DNPC and determining that the indirect bit is set (indicating an indirect branch instruction). When an indirect branch is indicated, the branch target can be generated from the INPC (when the tag results in a hit).

The flow 200 includes generating a second branch target address 220. Embodiments include generating, by the INPC, a second branch target address. Disclosed implementations may include a first branch prediction strategy for direct branch instructions (such as a DNPC), and a second branch prediction strategy for indirect branch instructions (such as an INPC). The generation of the second branch target address can be performed by the INPC. The generation of the address can be based on a hit on the tag within the INPC. When a hit is produced, the INPC can produce a stored target address, which can be the second branch target address. In embodiments, the producing and the generating occur on the same cycle. Recall that the DNPC can produce a branch target address. The producing of an address by the DNPC and the generating of a second address by the INPC can occur on the same processor cycle.

In embodiments, the indirect bit is set within the entry of the DNPC that matches the tag. Recall that an indirect bit can be within the DNPC. The indirect bit can indicate whether a branch instruction that has been fetched is recognized as a direct or indirect branch instruction. As described above, the DNPC and the INPC can be accessed on the same cycle. Thus, the DNPC can produce a target address and the INPC can generate a second target address on the same cycle. Embodiments include selecting the second branch target address 230. In the case where the indirect bit is set, a target address from the INPC can be selected. The selecting of the second branch target address can include loading the second branch target address into a hardware block used for speculatively fetching instructions.

Embodiments include predicting the branch instruction as taken 240. Indirect branches can be challenging to predict accurately. Execution of both direct and indirect branches can benefit from a prediction (e.g., “taken” or “not taken”). However, indirect branches can also require a prediction of a target address since it may vary dynamically at runtime depending on program state, function pointers, return addresses, or other data-dependent behavior. In such cases, implementing complex prediction logic may add substantial hardware cost without yielding proportionate gains in prediction accuracy. Accordingly, in some disclosed implementations, it can be advantageous to simplify the prediction of indirect branches. Embodiments include predicting the branch instruction as taken.

The flow 200 includes fetching instructions 250. Embodiments include fetching, by the processor core, a next block of instructions, wherein the fetching is based on the second branch target address. The fetched instructions can be based on predicting an indirect branch to be taken. Indirect branch instructions play a crucial role in modern computing architectures, often used in programming patterns where control flow intentionally jumps to different parts of code, based on dynamic information like data values, function calls, or dispatch mechanisms. These kinds of instructions can be associated with control transfers that are inherently expected to occur. These instructions can include function returns, where the processor returns to a previous execution thread after a function call. Function returns, a fundamental aspect of subroutine execution, are frequently implemented as indirect branch instructions and are almost always taken. The instructions can include virtual function calls, which introduce an additional layer of dynamism since the actual target address is determined at runtime. These branches are commonly taken because the program is intentionally jumping to a method implementation. Consequently, indirect branches can be used to implement runtime behaviors, facilitating smooth execution flow across dynamic program structures. Thus, indirect branches are usually intended to transfer control to a different location. Therefore, it can often be more likely for an indirect branch to actually be taken, rather than simply falling through to the next instruction. In contrast, direct branches, such as simple if-else statements, often can have a behavior that exhibits a more balanced likelihood between being taken and not taken, since the direct branch instructions can depend on runtime conditions that may or may not be true. Disclosed implementations leverage this inherent software characteristic to achieve additional branch prediction accuracy, thereby improving overall processor performance by minimizing costly mispredictions and enhancing instruction throughput. Embodiments can further include fetching, by the processor core, a next block of instructions, wherein the fetching is based on the second branch target address.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

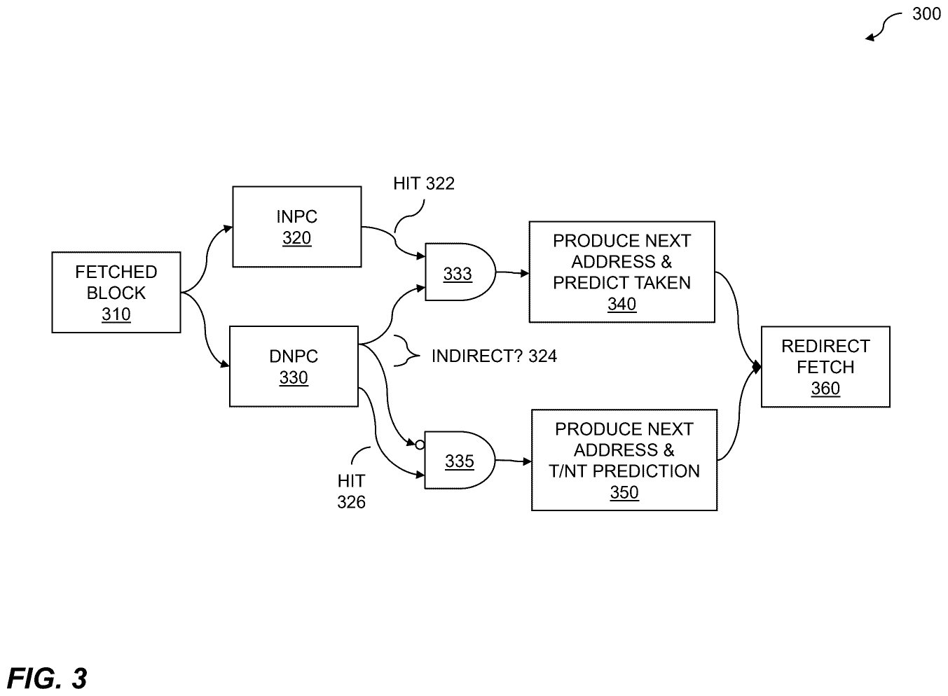

FIG. 3 is a block diagram for fetching instructions with next program counter caches. The block diagram 300 includes a fetched block 310. The fetched block 310 can include a sequence of one or more instructions that are fetched from an instruction cache, or another suitable source of program instructions. The instructions can be simultaneously checked within an indirect next program counter cache (INPC) 320, and a direct next program counter cache (DNPC) 330. Thus, in embodiments, the processor core includes an indirect next program counter cache (INPC). In embodiments, the INPC comprises content addressable memory (CAM). The content addressable memory (CAM) is a specialized type of memory optimized for high-speed search operations, allowing data retrieval based on content rather than specific memory addresses. The CAM can be configured to perform parallel comparisons across all stored entries simultaneously. When searching for a given entry, the input search key can be broadcast to every stored location in the CAM, where dedicated comparison circuits can be used to check for a match in a single clock cycle. If a matching entry is found, the CAM can output its corresponding index or associated data. If multiple matches exist, priority encoding and/or other resolution mechanisms can be used to determine the best match. This highly parallel search process makes CAM ideal for applications requiring rapid lookup operations, such as looking up a branch target address based on an input key such as a program counter value, a portion of a program counter value, or a hash value based on a program counter. Embodiments can include locating, in the INPC, an entry that matches the tag. In embodiments, the finding and the locating occur on a same cycle.

The DNPC 330 can include an indirect bit that is set if the branch instruction is an indirect branch instruction, and cleared if the branch instruction is a direct branch instruction. The status of the indirect bit 324 is provided as an input to INPC logic 333 and DNPC logic 335. Additionally, a corresponding hit signal 326 for the DNPC 330 and hit signal 322 for the INPC 320 serve as inputs to the DNPC logic 335 and INPC logic 333, respectively. In disclosed implementations, there can be a hit in both the INPC 320 and the DNPC 330 for a given instruction. In cases where the indirect bit of the DNPC 330 is not set, the direct branch prediction processing is performed, generating a next address along with a taken/not taken prediction 350. In cases where the indirect bit of the DNPC 330 is set, specialized indirect branch processing is performed, where a next address is produced, and the branch is systematically predicted to be taken 340. Thus, embodiments can include generating, by the INPC, a second branch target address. In embodiments, the producing and the generating occur on the same cycle.

As stated previously, predicting each indirect branch to be taken can optimize branch prediction efficiency while reducing hardware complexity. For direct branches, a history-based branch prediction approach can be used to dynamically adapt to execution patterns, exploiting program trends, program locality, and so on. The output of the branch prediction can cause a redirect of fetch 360. The redirect fetch can include fetching one or more instructions from a new target address based on the branch prediction outcome. In disclosed implementations, every indirect branch instruction causes a redirect fetch. Additionally, for direct branch instructions, only those predicted to be taken trigger a redirect fetch. Conversely, direct branch instructions predicted to be not taken proceed with sequential instruction fetching, avoiding unnecessary disruptions to the execution flow. In this way, for code constructs that include rarely taken branches (such as a branch based on an unusual or rare condition), the branch prediction process of disclosed implementations can leverage predictive heuristics to provide improved branch prediction performance.

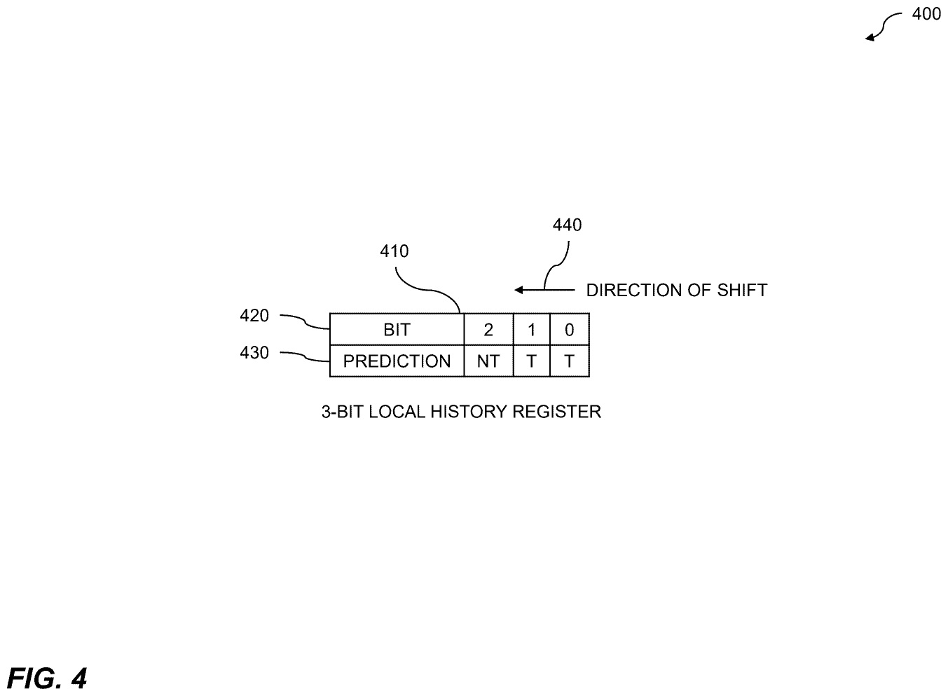

FIG. 4 is a diagram of a 3-bit local history register. For the purpose of explaining the operation of the local history register in the diagram 400, the register 410 is shown as a three-bit local history register. In practice, the local history register can be configured with varying bit-widths, such as two-bit, three-bit, or four-bit sizes, or other suitably optimized register depths based on architectural requirements. Each bit 420 within the register 410 represents a sequential record of temporal branch prediction occurrences. In disclosed implementations, the most recent branch instruction outcome is placed in the bit 0 location of register 410. Upon receiving the next branch instruction outcome, the stored values undergo a leftward shift, as indicated at 440, ensuring that the latest prediction data is efficiently incorporated into the register structure. Each bit value encapsulates the historical result of a prediction 430. As shown in the diagram 400, an “NT” in a bit location is indicative of a branch not being taken, and a “T” in a bit location is indicative of a branch being taken. In practice, a binary encoding methodology may be employed, where a “1” in a bit location denotes a taken branch, and a “0” in a bit location signifies a branch that was not taken. When a new branch instruction outcome is available, a structured shift operation can be performed, and the oldest branch outcome is systematically removed from the register to maintain an accurate rolling history of branch execution behavior. In some implementations, the branch outcome can be a speculative prediction derived from previously observed trends. In some implementations, the branch outcome can be the actual execution result (determined after instruction completion). In disclosed implementations, a configurable operational mode may be employed, enabling dynamic selection between using an actual outcome or a predicted outcome, thereby enhancing adaptability for execution of various types of programs and/or operational scenarios.

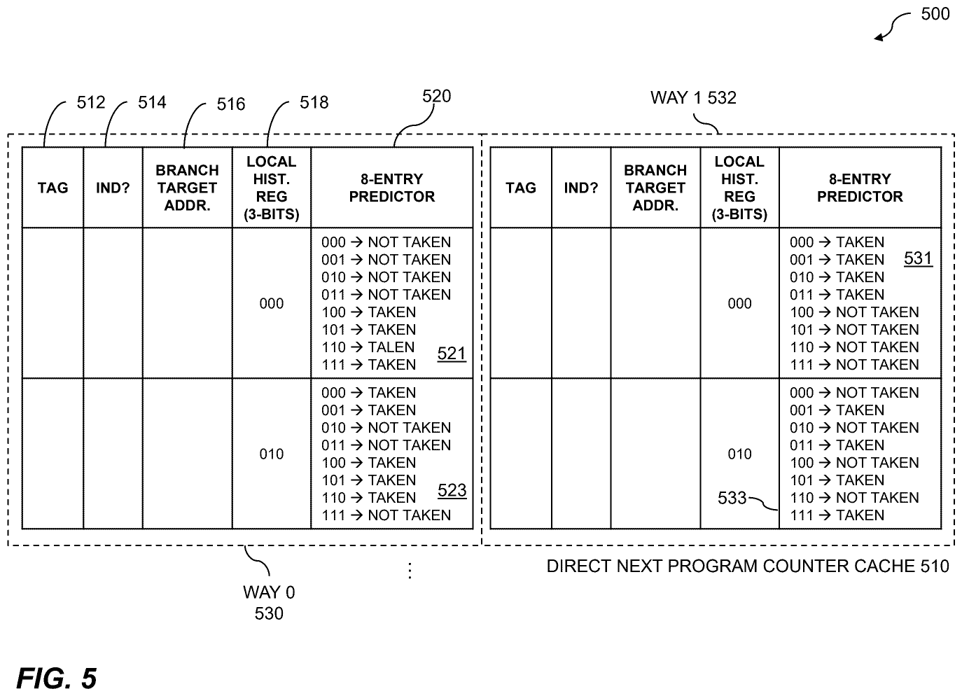

FIG. 5 is a diagram of a DNPC. The DNPC can be implemented as N-way associative memory. As shown in the diagram 500, the DNPC 510 is implemented as a 2-way associative memory, including way 0 530 and way 1 532. Referring to way 0 530, there is a first column 512 indicating a tag. In disclosed implementations, the tag can include a program counter (PC) value, a subset of a PC value (e.g., least significant 10 bits), a hash value (e.g., a hash of the program counter, a hash of the program counter XORed with a history register, and the like), and so on. A second column 514 includes a bit value representing the indirect bit. A third column 516 stores a branch target address. The third column can include 32 bits, 64 bits, 128 bits, or another width suitable for storing a branch target address, based on architectural requirements. A fourth column 518 stores a local history register (LHR) value. The value in column 518 can be a three-bit value, based on a local history register such as depicted in FIG. 4. A fifth column can include a multiple entry predictor. The number of entries can be based on a width of N bits for the local history register. In the examples illustrated herein, the local history register is 3 bits, and accordingly, the multiple entry predictor includes 8 (2\hat{ }3) entries. Way 1 532 includes similar columns as described for way 0 530.

In disclosed implementations, during operation, the predictions corresponding to different entries in the multiple entry predictor column 520 can be updated based on global prediction results. In disclosed implementations, results from a TAGE branch predictor and/or TAGE cache can be used to update the entries in the multiple entry predictor column 520 as the processor executes. In some implementations, the TAGE branch predictor and/or TAGE cache values are based on branch commit results. In some implementations, updating the DNPC values is based on branch execution results. Embodiments can include updating the LHR based on execution of the branch instruction.

With the dynamic prediction table update of disclosed implementations, the predictions for a given entry can change during the course of program execution. As an example, the prediction table 521 shows an initial state, in which the branch prediction corresponding to values 000-011 corresponds to a “not taken” prediction, while a branch prediction corresponding to values 100-111 corresponds to a “taken” prediction. The prediction table 523 for a different row (corresponding to a different tag/instruction) shows a different arrangement after “warm up” in which values 000 and 001 correspond to a “taken” prediction, values 010 and 011 correspond to a “not taken” prediction, values 100-110 correspond to a “taken” prediction, and value 111 corresponds to a “not taken” prediction. Similarly, prediction table 531 and prediction table 533 also show different prediction values as compared with the initial state shown in table 521, based on program execution.

In disclosed implementations, an initialization sequence of the multiple entry prediction table can include fetching and processing a direct branch instruction for which no entry currently exists in the DNPC 510, thereby causing a “miss” in the DNPC 510. Based on the miss, a new entry can be dynamically allocated for the tag. The corresponding local history register entry can be initialized to a value of “000” (which can indicate no available history). A prediction from a global history predictor (such as a TAGE branch predictor and/or TAGE cache) can be obtained, leveraging broader execution trends to inform the prediction process. The table entry pointed to by the current LHR value can be updated (e.g., toggled between “taken” and “not taken”) based on the additional branch predictor (which can be based on global branch history), and depending on the prediction, the LHR value can then be updated to point to a neighboring entry (incrementing from “001” to “010,” for example). In embodiments, the updating is based on a prediction from an additional branch predictor. In embodiments, the additional branch predictor comprises a tagged geometric (TAGE) branch predictor. In embodiments, the additional branch predictor comprises a tagged geometric (TAGE) cache. The TAGE cache can store recent predictions from the TAGE branch predictor. The LHR updating process can repeat for each execution of a given direct branch instruction. Over time, the table values transition from an initial state, such as depicted in table 521, to a fully adapted “warmed-up” state, as shown in table 523, table 531, and table 533. In this way, disclosed implementations efficiently map extensive global history data, which can include multiple bits of history, into compact yet high-speed local history registers that enable rapid access for branch prediction, optimizing performance while incorporating the accuracy benefits derived from global history analysis. In embodiments, the DNPC comprises a two-way set associative cache.

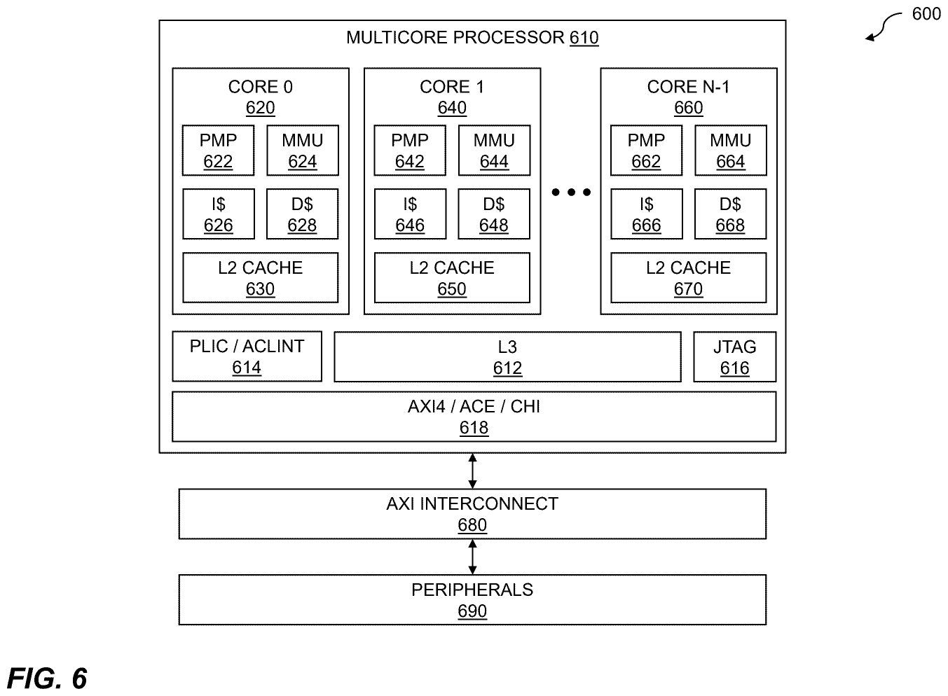

FIG. 6 is a block diagram of a multicore processor. The processor, such as a RISC-V™ processor, an ARM processor, or another suitable processor type, can include a variety of elements. The elements can include processor cores including multiprocessor cores, one or more caches including local caches and shared caches, memory protection and management units, local storage, and so on. The elements of the multicore processor can further include one or more of a private cache; a test interface such as a joint test action group (JTAG) test interface; one or more interfaces to a network such as a network-on-chip, shared memory, and peripherals; and the like.

In the block diagram 600, the multicore processor 610 can comprise two or more processors, where the two or more processors can include homogeneous processors, heterogeneous processors, etc. In the block diagram, the multicore processor can include N processor cores such as core 0 620, core 1 640, core N−1 660, and so on. Each processor can comprise one or more elements. In one or more implementations, each core, including cores 0 through core N−1, can include a physical memory protection (PMP) element, such as PMP 622 for core 0, PMP 642 for core 1, and PMP 662 for core N−1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 624 for core 0, MMU 644 for core 1, and MMU 664 for core N−1. The memory management units can translate virtual addresses used by software running on the cores to physical memory addresses with caches, the shared memory system, etc.

The processor cores associated with the multicore processor 610 can include caches such as instruction caches and data caches. The caches, which can comprise level 1 (L1) caches, can include an amount of storage such as 16 KB, 32 KB, and so on. The caches can include an instruction cache I$ 626 and a data cache D$ 628 associated with core 0, an instruction cache I$ 646 and a data cache D$ 648 associated with core 1, and an instruction cache I$ 666 and a data cache D$ 668 associated with core N−1. In addition to the level 1 instruction and data caches, each core can include a level 2 (L2) cache. The level 2 caches can include L2 cache 630 associated with core 0; L2 cache 650 associated with core 1; and L2 cache 670 associated with core N−1. The cores associated with the multicore processor 610 can include further components or elements. The further elements can include a level 3 (L3) cache 612. The level 3 cache, which can be larger than the level 1 instruction and data caches and the level 2 caches associated with each core, can be shared among all of the cores. The further elements can be shared among the cores. In one or more implementations, the further elements can include a platform level interrupt controller (PLIC) 614. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 616. The JTAG can provide a boundary within the cores of the multicore processor. The JTAG can enable fault information to a high precision. The high-precision fault information can be critical to rapid fault detection and repair.

The multicore processor 610 can include one or more interface elements 618. The interface elements can support standard processor interfaces including an Advanced eXtensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. In the block diagram 600, the interface elements can be coupled to the interconnect. The interconnect can include a bus, a network, and so on. The interconnect can include an AXI™ interconnect 680. In one or more implementations, the network can include network-on-chip functionality. The AXI™ interconnect can be used to connect memory-mapped “master” or boss devices to one or more “slave” or worker devices. In the block diagram 600, the AXI interconnect can provide connectivity between the multicore processor 610 and one or more peripherals 690. The one or more peripherals can include storage devices, networking devices, and so on. The peripherals can enable communication using the AXI™ interconnect by supporting standards such as AMBA™ version 4, among other standards.

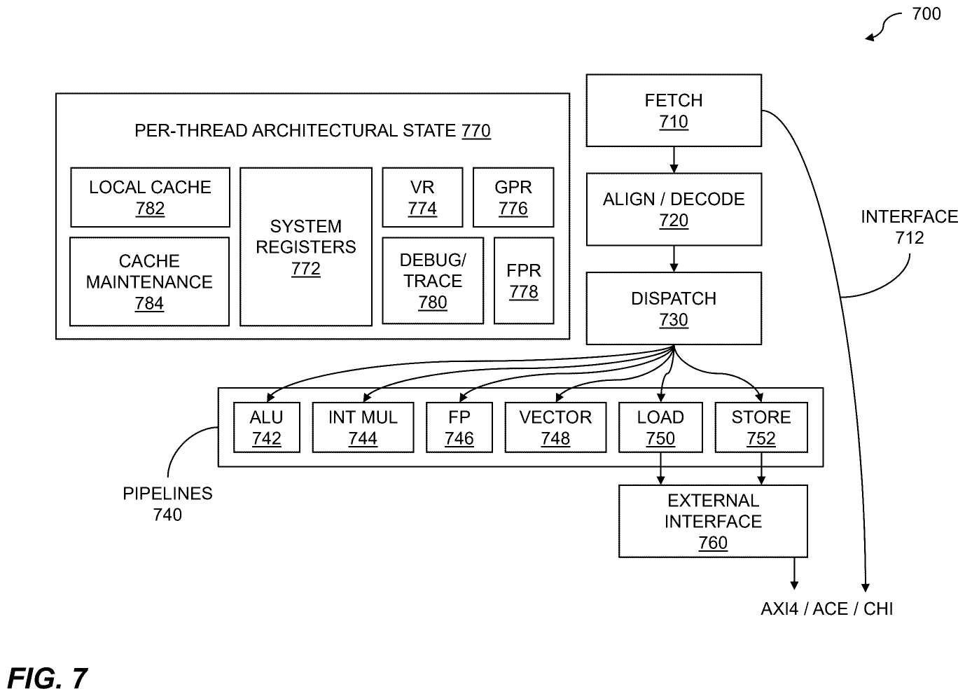

FIG. 7 is a block diagram of a pipeline. One or more pipelines associated with a processor architecture can be used to greatly enhance processing throughput. The processor architecture can be associated with one or more processor cores. The processing throughput can be increased because multiple operations can be executed in parallel. In one or more implementations, a processor core is accessed. The processor core is coupled to a memory hierarchy, and the processor core is configured to execute vector operations, scalar operations, and various micro-operations that implement architectural instructions.

The blocks within the block diagram can be configurable in order to provide varying processing levels. The varying processing levels can be based on processing speed, bit lengths, word lengths, numbers of micro-operations, and so on. The block diagram 700 can include a fetch block 710. The fetch block 710 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 712. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 700 includes an align and decode block 720. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decode packets. The decode packets can be used in the pipeline to manage execution of operations. The block diagram 700 can include a dispatch block 730. The dispatch block can receive decoded instruction packets from the align and decode block. The decoded instruction packets can be used to control a pipeline 740, where the pipeline can include an in-order pipeline, an out-of-order (OoO) pipeline, etc. In one or more exemplary implementations, the processor core executes one or more instructions out of order. A pipeline can be associated with the one or more execution units. The pipelines associated with the execution units can include processor cores, arithmetic logic unit (ALU) pipelines 742, integer multiplier pipelines 744, floating-point unit (FPU) pipelines 746, vector unit (VU) pipelines 748, and so on. The dispatch unit can further dispatch instructions to pipelines that can include load pipelines 750 and store pipelines 752. The load pipelines and the store pipelines can access storage such as the common memory using an external interface 760. The external interface can be based on one or more interface standards such as the Advanced eXtensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In one or more exemplary implementations, the plurality of processors can be configured to support multi-threading. The system block diagram can include a per-thread architectural state block 770. The inclusion of the per-thread architectural state can be based on a configuration or architecture that can support multi-threading. In one or more exemplary implementations, thread selection logic can be included in the fetch and dispatch blocks discussed above. The per-thread architectural state can include system registers 772. The system registers can be associated with individual processors, a system comprising multiple processors, and so on. The system registers can include exception and interrupt components, counters, etc. The per-thread architectural state can include further registers such as vector registers (VRs) 774. The vector registers can be grouped in a vector register file and can be used for vector operations. In one or more exemplary implementations, the width of the vector register file is 512 bits. Additional registers, such as general-purpose registers (GPRs) 776 and floating-point registers (FPRs) 778, can be included. These registers can be used for general purpose (e.g., integer) operations and floating-point operations, respectively. The per-thread architectural state can include a debug and trace block 780. The debug and trace block can enable debug and trace operations to support code development, troubleshooting, and so on. In one or more exemplary implementations, an external debugger can communicate with a processor through a debugging interface such as a joint test action group (JTAG) interface. The per-thread architectural state can include a local cache state 782. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 784. The cache maintenance state can include maintenance needed, maintenance pending, and maintenance complete states, etc.

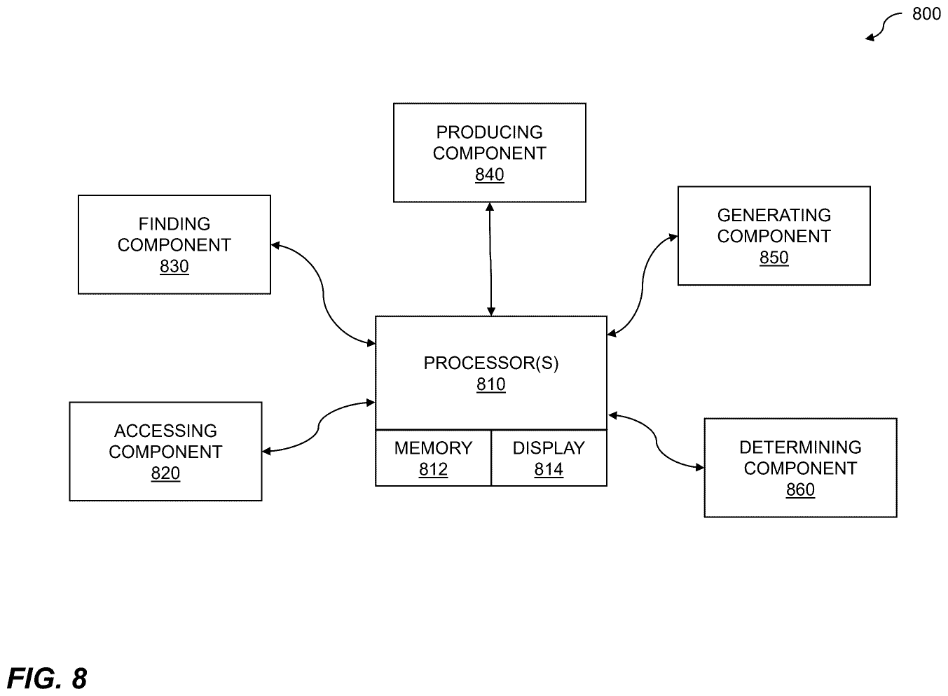

FIG. 8 is a system diagram for branch prediction with next program counter caches. The system 800 can include instructions and/or functions for design, generation of semiconductor logic for, and implementation of integrated circuits that support branch prediction with next program counter caches. The system 800 can include instructions and/or functions for generation and/or manipulation of design data such as hardware description language (HDL) constructs for specifying structure and operation of an integrated circuit. The system 800 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system can include one or more of processors, memories, cache memories, displays, and so on. The system 800 can include one or more processors 810. The processors can include standalone processors, processors within integrated circuits or chips, processor cores in FPGAs or ASICs, and so on. The one or more processors 810 are coupled to a memory 812, which stores instructions. The memory can include one or more of local memory, cache memory, system memory, etc. The system 800 can further include a display 814 coupled to the one or more processors 810. The display 814 can be used for displaying data, instructions, operations, micro-operations, operations using branch prediction with next program counter caches, and the like. The operations can include instructions and functions for implementation of integrated circuits, including processor cores. In exemplary implementations, the processor cores can include RISC-V™ processor cores. A system comprising the one or more processors 810, when executing the instructions which are stored in the memory 812, is configured to enable branch prediction with next program counter caches.

The system 800 can include an accessing component 820. The accessing component 820 can include functions and instructions for accessing a processor core, wherein the processor core is configured to predict branch instructions, wherein the processor core includes a direct next program counter cache (DNPC), wherein the DNPC comprises a plurality of entries, and wherein the processor core fetches a branch instruction, wherein the branch instruction is associated with a program counter (PC) address. The processor core can include an ARM core, a MIPS core, and/or other suitable core type. In one or more exemplary implementations, the processor core can include a RISC-V architecture. The processor core can be configured to execute instructions and/or micro-operations.

The system 800 can include a finding component 830. The finding component 830 can include functions and instructions for finding, within the DNPC, an entry, within the plurality of entries, that matches a tag, wherein the tag is associated with the PC address, and wherein the finding includes reading an indirect bit within the entry of the DNPC that matches the tag. The tag can include a full PC value, a partial PC value, a hashed value, a combined value (e.g., based on a PC value combined with one or more history bits), and so on.

The system 800 can include a producing component 840. The producing component 840 can include functions and instructions for producing, by the DNPC, a branch target address for the branch instruction, wherein the indirect bit is not set within the entry of the DNPC that matches the tag. This feature can exploit program behavior in which direct branches may be predicted to be “not taken” under certain conditions, such as case statements and if-else constructs to handle rare or unusual events. Thus, while in disclosed implementations, indirect branches may be assumed to always be taken, direct branches utilize prediction techniques to determine if they are likely to be taken or not taken.

The system 800 can include a generating component 850. The generating component 850 can include functions and instructions for generating, by the DNPC, a prediction for the branch instruction, wherein the prediction is based on a local history register (LHR) within the entry of the DNPC that matched the tag. While the prediction is based on a value in an LHR, the LHR value can be informed by information, in a global history register, which can be derived from a sophisticated, multi-layered branch prediction system such as a TAGE branch predictor coupled to a TAGE cache. In this way, disclosed implementations can seamlessly combine the granular accuracy of a global history branch prediction with the low-latency, high-speed access enabled by small, local history registers, striking an effective balance between precision and performance.

The system 800 can include a determining component 860. The determining component 860 can include functions and instructions for determining a next PC address, wherein the determining is based on the producing and the generating. In the case of an indirect branch instruction, the determining can include a mandatory redirection mechanism, informed by speculative execution of the predicted taken branch, ensuring seamless control flow transitions. In the case of a direct branch instruction, the determining can include conditional redirection, based on a “taken” prediction as indicated in a corresponding local history register, or alternatively, executing a sequential instruction path, based on a “not taken” prediction as indicated in a corresponding local history register. This dynamic selection process can enhance execution efficiency by aligning branch resolution strategies with historical program behavior, improving predictive accuracy and minimizing unnecessary stalls in instruction flow.

The system 800 can include a computer program product embodied in a non-transitory computer readable medium for instruction execution, the computer program comprising code which causes one or more processors to generate semiconductor logic for: accessing a processor core, wherein the processor core is configured to predict branch instructions, wherein the processor core includes a direct next program counter cache (DNPC), wherein the DNPC comprises a plurality of entries, and wherein the processor core executes a branch instruction, wherein the branch instruction is associated with a program counter (PC) address; finding, within the DNPC, an entry within the plurality of entries, that matches a tag, wherein the tag is associated with the PC address, and wherein the finding includes reading an indirect bit within the entry of the DNPC that matches the tag; producing, by the DNPC, a branch target address for the branch instruction, wherein the indirect bit is not set within the entry of the DNPC that matches the tag; generating, by the DNPC, a prediction for the branch instruction, wherein the prediction is based on a local history register (LHR) within the entry of the DNPC that matched the tag; and determining a next PC address, wherein the determining is based on the producing and the generating.

The system 800 can include a computer system for instruction execution comprising: a memory which stores instructions; one or more processors coupled to the memory wherein the one or more processors, when executing the instructions which are stored, are configured to: access a processor core, wherein the processor core is configured to predict branch instructions, wherein the processor core includes a direct next program counter cache (DNPC), wherein the DNPC comprises a plurality of entries, and wherein the processor core executes a branch instruction, wherein the branch instruction is associated with a program counter (PC) address; find, within the DNPC, an entry, within the plurality of entries, that matches a tag, wherein the tag is associated with the PC address, and wherein the finding includes reading an indirect bit within the entry of the DNPC that matches the tag; produce, by the DNPC, a branch target address for the branch instruction, wherein the indirect bit is not set within the entry of the DNPC that matches the tag; generate, by the DNPC, a prediction for the branch instruction, wherein the prediction is based on a local history register (LHR) within the entry of the DNPC that matched the tag; and determine a next PC address, wherein the determining is based on the producing and the generating.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions-generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented (processor-implemented) methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for instruction execution comprising:
accessing a processor core, wherein the processor core is configured to predict branch instructions, wherein the processor core includes a direct next program counter cache (DNPC), wherein the DNPC comprises a plurality of entries, and wherein the processor core executes a branch instruction, wherein the branch instruction is associated with a program counter (PC) address;
finding, within the DNPC, an entry, within the plurality of entries, that matches a tag, wherein the tag is associated with the PC address, and wherein the finding includes reading an indirect bit within the entry of the DNPC that matches the tag;
producing, by the DNPC, a branch target address for the branch instruction, wherein the indirect bit is not set within the entry of the DNPC that matches the tag;
generating, by the DNPC, a prediction for the branch instruction, wherein the prediction is based on a local history register (LHR) within the entry of the DNPC that matched the tag; and
determining a next PC address, wherein the determining is based on the producing and the generating.

2. The method of claim 1 wherein the DNPC includes a plurality of prediction tables, wherein each prediction table within the plurality of prediction tables is associated with each entry within the plurality of entries within the DNPC.

3. The method of claim 2 wherein the generating includes indexing, by the LHR, into a prediction table within the entry of the DNPC that matched the tag.

4. The method of claim 2 further comprising updating the LHR.

5. The method of claim 4 wherein the updating is based on a prediction from an additional branch predictor.

6. The method of claim 5 wherein the additional branch predictor comprises a tagged geometric (TAGE) cache.

7. The method of claim 5 wherein the additional branch predictor comprises a tagged geometric (TAGE) branch predictor.

8. The method of claim 4 further comprising updating the LHR based on execution of the branch instruction.

9. The method of claim 2 wherein the finding includes allocating a new entry within the DNPC.

10. The method of claim 9 further comprising initializing the LHR and a prediction table within the new entry, wherein the initializing is based on a prediction from an additional branch predictor.

11. The method of claim 1 wherein the processor core includes an indirect next program counter cache (INPC).

12. The method of claim 11 wherein the INPC comprises a content addressable memory (CAM).

13. The method of claim 11 further comprising locating, in the INPC, an entry that matches the tag.

14. The method of claim 13 wherein the finding and the locating occur on a same cycle.

15. The method of claim 14 further comprising generating, by the INPC, a second branch target address.

16. The method of claim 15 wherein the producing and the generating occur on the same cycle.

17. The method of claim 16 wherein the indirect bit is set within the entry of the DNPC that matches the tag.

18. The method of claim 17 further comprising selecting the second branch target address.

19. The method of claim 18 further comprising predicting the branch instruction as taken.

20. The method of claim 19 further comprising fetching, by the processor core, a next block of instructions, wherein the fetching is based on the second branch target address.

21. The method of claim 1 wherein the DNPC comprises a two-way set associative cache.

22. The method of claim 1 further comprising fetching, by the processor core, one or more instructions, wherein the fetching is based on the determining.

23. A computer program product embodied in a non-transitory computer readable medium for instruction execution, the computer program product comprising code which causes one or more processors to generate semiconductor logic for:
accessing a processor core, wherein the processor core is configured to predict branch instructions, wherein the processor core includes a direct next program counter cache (DNPC), wherein the DNPC comprises a plurality of entries, and wherein the processor core executes a branch instruction, wherein the branch instruction is associated with a program counter (PC) address;
finding, within the DNPC, an entry, within the plurality of entries, that matches a tag, wherein the tag is associated with the PC address, and wherein the finding includes reading an indirect bit within the entry of the DNPC that matches the tag;
producing, by the DNPC, a branch target address for the branch instruction, wherein the indirect bit is not set within the entry of the DNPC that matches the tag;
generating, by the DNPC, a prediction for the branch instruction, wherein the prediction is based on a local history register (LHR) within the entry of the DNPC that matched the tag; and
determining a next PC address, wherein the determining is based on the producing and the generating.

24. A computer system for instruction execution comprising:
a memory which stores instructions;
one or more processors coupled to the memory wherein the one or more processors, when executing the instructions which are stored, are configured to:
access a processor core, wherein the processor core is configured to predict branch instructions, wherein the processor core includes a direct next program counter cache (DNPC), wherein the DNPC comprises a plurality of entries, and wherein the processor core executes a branch instruction, wherein the branch instruction is associated with a program counter (PC) address;
find, within the DNPC, an entry, within the plurality of entries, that matches a tag, wherein the tag is associated with the PC address, and wherein the finding includes reading an indirect bit within the entry of the DNPC that matches the tag;
produce, by the DNPC, a branch target address for the branch instruction, wherein the indirect bit is not set within the entry of the DNPC that matches the tag;
generate, by the DNPC, a prediction for the branch instruction, wherein the prediction is based on a local history register (LHR) within the entry of the DNPC that matched the tag; and
determine a next PC address, wherein the determining is based on the producing and the generating.
